(19) United States
(12) Patent Application Publication
(10) Pub. No.: US 2009/0269017 A1
(43) Pub. Date: Oct. 29, 2009

(54) Optical waveguide device

(75) Inventors: Shinji Maruyama, Kawasaki (JP); Yoshihiko Yoshida, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 12/318,312

(22) Filed: Dec. 24, 2008

(30) Foreign Application Priority Data
Apr. 28, 2008 (JP) 2008-116907

(51) Int. Cl. G02B 6/10

(52) U.S. Cl. 385/132

(57) ABSTRACT

In An optical waveguide device, an output light reflected by a reflective groove can be monitored with a phase identical to a signal light. The optical waveguide device includes a substrate; an optical waveguide formed in a plane of the substrate and having a normal line with a predetermined angle relative to an optical axis of the optical waveguide; a reflective groove formed on the optical waveguide; and a monitor device to monitor an output light reflected by the reflective groove, wherein the reflective groove has as much depth as approaching a half or less of a mode field of a waveguided light propagated through the optical waveguide, to reflect a portion of the waveguided light.

### CROSS-REFERENCE TO RELATED APPLICATIONS

This application is based upon and claims the benefit of priority of the prior Japanese Patent Application No. 2008-116907, filed on Apr. 28, 2008, the entire contents of which are incorporated herein by reference.

### FIELD

The embodiments discussed herein are directed to an optical waveguide device and a method for manufacturing the optical waveguide device.

### BACKGROUND

At present, as a modulation method in an optical transmission system, there are cases of using a Mach-Zehnder external modulator using LiNbO₃ (lithium niobate) etc. (hereafter referred to as LN modulator).

In particular, compared with direct modulation, the external modulator is advantageous in terms of a high-speed characteristic and a wavelength characteristic. Therefore, the external modulator is widely used in a 10-GHz band high-speed optical communication system.

FIG. 1 is a conceptual plan view of an exemplary configuration of the LN modulator as the external modulator.

An optical waveguide 3 is formed on a chip 1 of a LiNbO₃ substrate. Further, on the above chip 1, an electrode 2 functioning as a microwave transmission path for propagating a modulation signal is formed. Optical waveguide 3 includes a first optical waveguide 3A and a second optical waveguide 3B. By means of a 3-dB coupler 4A on the input side, an input optical signal is branched into the first optical waveguide 3A and the second optical waveguide 3B. Further, by means of a 3-dB coupler 4B on the output side, the optical signals transmitted through the first optical waveguide 3A and the second optical waveguide 3B are coupled. With the above configuration, a Mach-Zehnder interferometer is formed.

In case of a Z-cut modulator, an output light Pout of the LN modulator is expressed as follows:

Pout=4k(1−k)cos²(Δφ)

where,

k: coupler branch ratio in the Mach-Zehnder interferometer (normally 0.5)

Δφ: phase difference between the branches of the Mach-Zehnder interferometer.

FIG. 2 is a diagram illustrating a characteristic curve in which the above-mentioned output light Pout and a varied working point are described. Because of an applied voltage V supplied to electrode 2, the output light Pout is shifted between On and Off on the curve, centering the working point O.

However, the above LiNbO₃ external modulator (LN modulator) latently has a phenomenon (temperature drift) that the working point is shifted by temperature and a phenomenon (DC drift) that the working point is shifted when a direct current is made to flow.

Therefore, to enable working at a desired working point (output) O in FIG. 2, it is necessary to constantly monitor the output light and control a bias current (DC current) to be supplied on electrode 2. Therefore, a method of incorporating a monitor photodetector (hereafter referred to as monitor PD) inside the LN modulator has been proposed.

FIGS. 3A, 3B illustrate exemplary configurations of incorporating the monitor PD in the LN modulator.

As depicted in FIGS. 3A, 3B, the monitor PD incorporated in the LN modulator utilizes an unnecessary light generated at coupler portion 4B of the Mach-Zehnder interferometer.

FIG. 3A is an exemplary case of using a 1×2 coupler (such as a Y branch device). It is configured to detect the unnecessary light generated at coupler portion 4B, by means of a monitor PD which is disposed on an identical side to the output light. In this case, there is the restriction of a fiber connection area in which the output light from the chip is to be received. This makes it difficult to dispose the monitor PD on the same direction as the direction of the output light. As a result, it is necessary to dispose the monitor PD in a horizontal direction, i.e. a perpendicular direction to the direction of the Mach-Zehnder interferometer.

The configuration illustrated in FIG. 3B is an exemplary case of using a 2×2 coupler (such as a directional coupler). A reflective groove 5 is formed on LiNbO₃ substrate 1. The unnecessary light generated at coupler 4B is reflected by the above reflective groove 5. It is configured to detect the unnecessary light by means of a monitor PD being disposed on a perpendicular direction (horizontal direction) to the direction of the Mach-Zehnder interferometer.

Here, in any case of the configurations illustrated in FIGS. 3A, 3B, the phases between the output signal light Pout and the monitor light Pmon have the relationship of being mutually inverted, as can be understood from FIG. 3C indicating the above relationship. More specifically, when the signal light Pout is ON, the monitor light Pmon becomes OFF, while when the signal light Pout is OFF, the monitor light Pmon becomes ON.

In contrast, it is desired to detect the monitor light with an identical phase to the signal light Pout in the situation that a variety of transmission systems, such as a DPSK (differential phase shift keying) transmission system and a duo-binary transmission system allowing intersymbol interference (ISI) between neighboring signals, are being studied, in addition to the RZ (return-to-zero) or the NRZ (non-return-to-zero) transmission system as the signal mode.

According to the invention described in JAPANESE Unexamined Patent Application Publication No. 2001-215371 (Patent document 1), an introduction layer portion having a high refractive index is formed on a waveguide, and by means of a detector closely mounted thereon, an unnecessary light is monitored.

According to the invention described in Japanese Unexamined Patent Application Publication No. 2002-40304 (Patent document 2), a V-shaped groove is formed transversally across a waveguide from the upper face of a substrate, and by means of a detector disposed on the back face, an unnecessary light is monitored. Also, by forming a deep groove transversally and obliquely relative to a traveling direction across a vertical section, monitoring is performed by a detector disposed on the upper face.

According to the invention described in Japanese Unexamined Patent Application Publication No. 2003-98368 (Patent document 3), by forming a deep groove transversally and obliquely relative to a traveling direction from the upper face of a substrate, a reflective light is monitored in a horizontal direction.

The invention described in Patent document 1 is a method for monitoring with a phase identical to the signal light Pout. Because the monitor PD is directly disposed on the optical waveguide, there is a problem of necessitating complicated and precise manufacturing processes.

The inventions described in Patent documents 2, 3 are other methods for monitoring with an identical phase. However, because it is necessary to form a deep groove transversally across the waveguide, the structure becomes complicated.

### SUMMARY

Accordingly, in consideration of the aforementioned points, it is an object of the present invention to provide a configuration with a simple structure, enabling output of a monitor light with a phase identical to a signal light Pout.

In order to solve the aforementioned problems, an optical waveguide device includes a substrate; an optical waveguide being formed in a plane of the substrate and constituted of an input optical waveguide and an output waveguide; an electrode being formed on the substrate correspondingly to the optical waveguide; a reflective groove being formed on the output waveguide and having a normal line with a predetermined angle relative to an optical axis of the output waveguide; and a monitor device monitoring an output light reflected by the reflective groove.

Because the reflective groove is formed on the output waveguide, it becomes possible to monitor an output light reflected by the reflective groove with a phase identical to the signal light Pout.

Additional objects and advantages of the invention (embodiment) will be set forth in part in the description which follows, and in part will be obvious from the description, or may be learned by practice of the invention. The object and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF DRAWINGS

FIG. 1 is a conceptual plan view of an exemplary configuration of the LN modulator as the external modulator.

FIG. 2 is a diagram illustrating a characteristic curve in which the above-mentioned output light Pout and a varied working point are described.

FIG. 3A is an exemplary case of using a 1×2 coupler (such as a Y branch device).

FIG. 3B is an exemplary case of using a 2×2 coupler (such as a directional coupler).

FIG. 4A is a schematic plan view of an optical waveguide device, according to a first embodiment corresponding to the 1×2 coupler depicted in FIG. 3A.

FIG. 4B is a schematic plan view of an optical waveguide device, according to a first embodiment corresponding to the 2×2 coupler depicted in FIG. 3B.

FIG. 4C is a conceptual cross-sectional view of an A-A′ portion of optical waveguide 10 depicted in FIG. 4A.

FIG. 5 is a schematic cross-sectional view between A and A′ depicted in FIG. 4A.

FIG. 6 is a similar schematic cross-sectional view between A and A′ depicted in FIG. 4A.

FIG. 7 is an optical waveguide device having a feature that each optical waveguide of a pair of optical waveguides in the aforementioned Mach-Zehnder interferometer further configures a Mach-Zehnder interferometer.

FIG. 8 illustrates charts illustrating exemplary processes until the formation of the optical waveguide is completed.

FIG. 9 illustrates process charts to form reflective groove 20 corresponding to FIG. 4C.

FIG. 10 illustrates process charts to form reflective groove 20 corresponding to FIG. 6.

FIG. 11 illustrates charts illustrating an electrode formation process.

FIG. 12 illustrates charts illustrating exemplary processes of a second embodiment to form an optical waveguide using a dielectric and a polymer material.

FIG. 13 illustrates charts explaining a method for forming reflective groove 20 corresponding to FIG. 4.

FIG. 14 illustrates charts explaining a method for forming reflective groove 20 corresponding to FIG. 6.

FIG. 15 illustrates an electrode formation process as a second embodiment.

### DESCRIPTION OF EMBODIMENTS

The preferred embodiment of the present invention is described hereinafter referring to the charts and drawings.

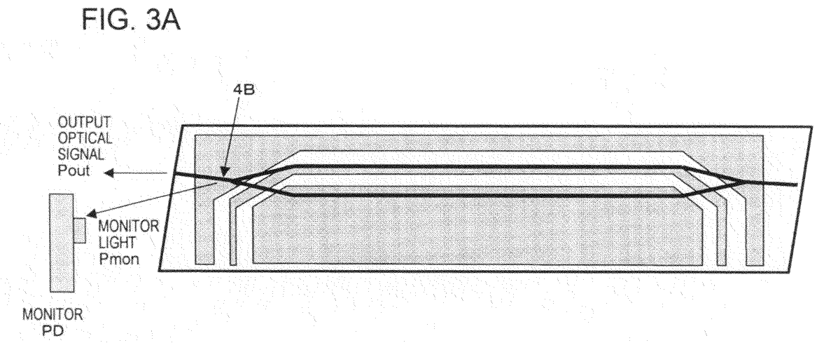

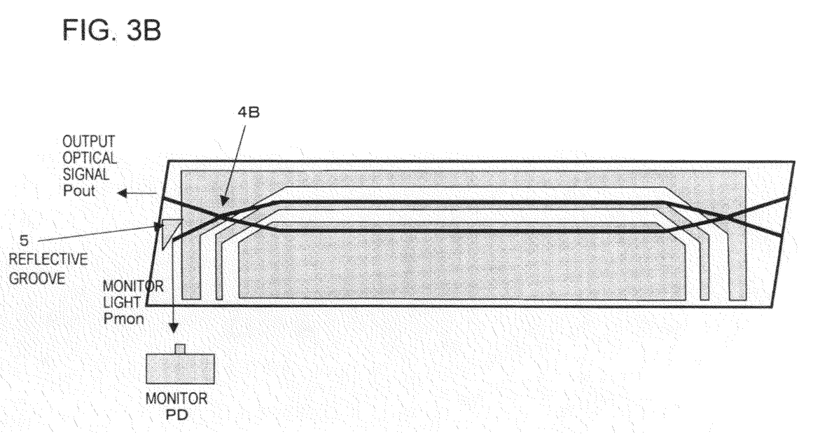

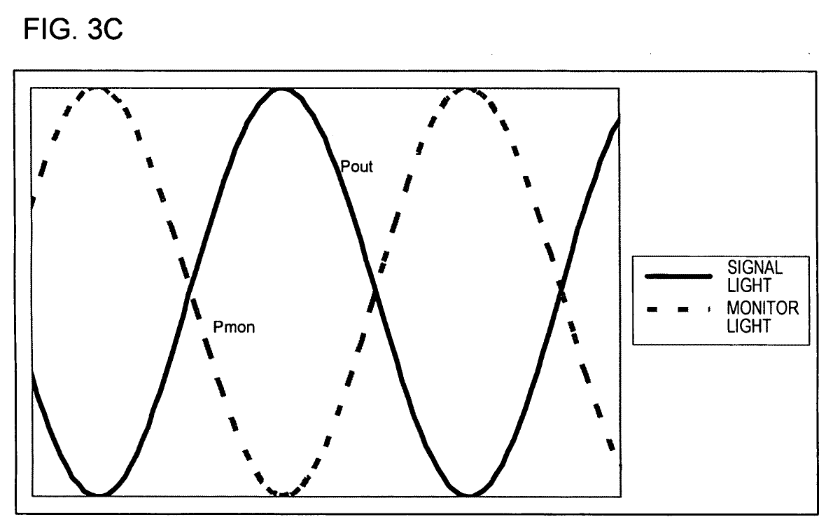

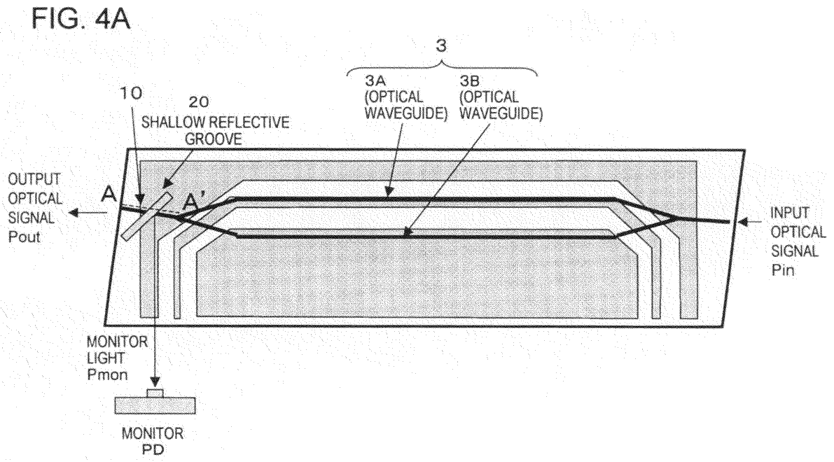

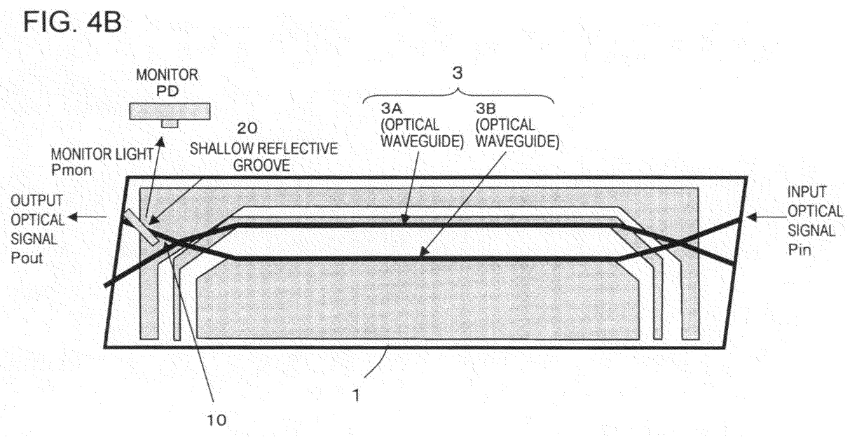

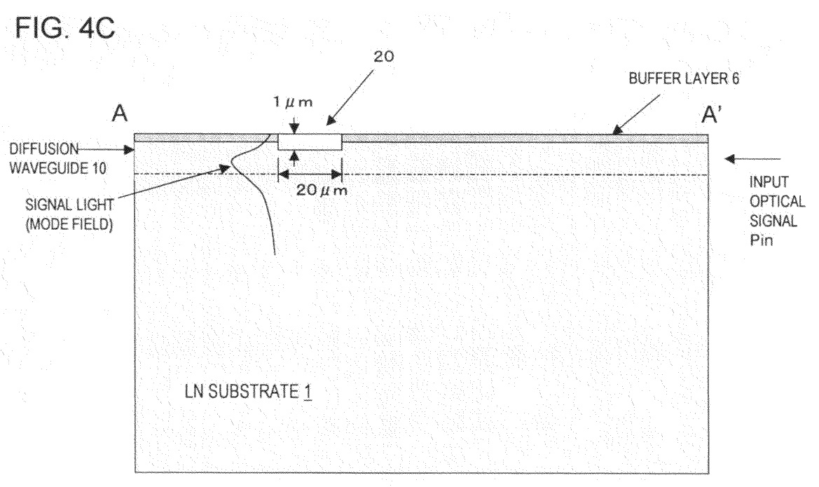

FIG. 4A illustrates a schematic plan view of an optical waveguide device, according to a first embodiment corresponding to the 1×2 coupler depicted in FIG. 3A. FIG. 4B illustrates a schematic plan view of an optical waveguide device, according to a first embodiment corresponding to the 2×2 coupler depicted in FIG. 3B.

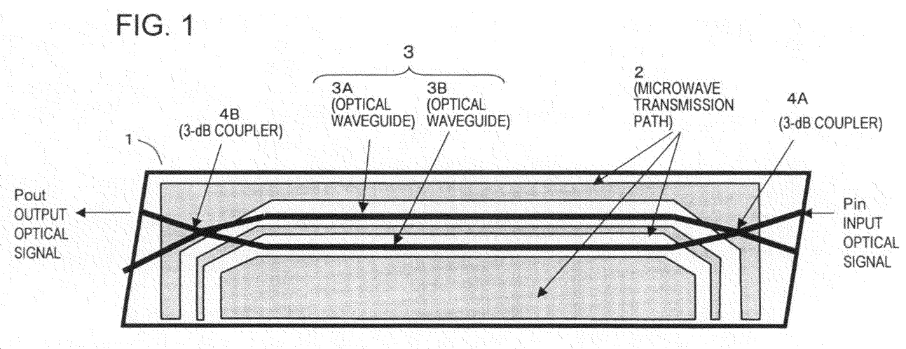

The optical waveguide devices depicted in FIGS. 4A, 4B are obtained by cutting out from a wafer sheet into a chip shape. As illustrated in FIG. 1, an optical waveguide 3 is formed on a single chip 1 being cut out from a wafer of a LiNbO₃ substrate. On the above optical waveguide 3, an electrode 2 functioning as a microwave transmission path for propagating a modulation signal is formed.

Optical waveguide 3 includes a first optical waveguide 3A and a second optical waveguide 3B. By means of a 3-dB coupler 4A disposed on the input side, an input optical signal is branched into the first optical waveguide 3A and the second optical waveguide 3B. Further, by means of a 3-dB coupler 4B disposed on the output side, optical signals propagated through the first optical waveguide 3A and the second optical waveguide 3B are coupled. As such, a Mach-Zehnder interferometer is configured.

On a signal light waveguide 10 between the Mach-Zehnder interferometer and the output end of the chip, a discontinuous waveguide portion is formed by a reflective groove 20. Here, reflective groove 20 has a width of several μm to several tens of μm and a shallow depth of the order of 1 μm, and is disposed transversally and obliquely relative to the optical axis of the signal light waveguide 10.

A portion of the signal light propagated through optical waveguide 10 is reflected on the discontinuous waveguide portion produced by the above-mentioned shallow reflective groove 20, and collected at the chip side face. The collected monitor light is received by a monitor PD disposed on the side face of the chip.

An optical loss produced at the discontinuous waveguide portion by reflective groove 20, which is minute in width and shallow in depth, is extremely small. Therefore, there is produced a small influence which is not so great as deteriorating the device characteristic.

Here, depending on an angle produced by the optical axis of reflective groove 20 at the discontinuous waveguide portion, the monitor light becomes incident perpendicularly to the chip side face. The monitor light is then reflected on the chip side face, so as to return intact to reflective groove 20. Further, on reflective groove 20, the monitor light is reflected toward Pin, the input side of the waveguide, which is not preferable for use as an external modulator.

Further, if an incident angle on the side wall of the chip is large, total reflection is produced in case of a material having a large refractive index such as LiNbO₃ (LN). This may cause incapability of being input to the monitor PD.

FIG. 4C is a conceptual cross-sectional view of an A-A′ portion of optical waveguide 10 depicted in FIG. 4A. On an upper layer area of LN substrate 1, a diffusion waveguide 10 having a depth of 7-10 μm is formed.

The above diffusion waveguide 10 has a mode field in which the signal light power is spread in upward and downward directions.

On the upper layer portion of waveguide 10 formed by diffusion, there is formed a shallow reflective groove 20 of approximately 1 μm in thickness and approximately 20 μm in width. An unnecessary light reflected by the above shallow reflective groove 20 is used as monitor light Pmon. An area in which the above reflective groove 20 is formed is an upper layer portion of waveguide 10, which is therefore a skirt area of the mode field. Accordingly, an influence upon the level of an output optical signal Pout is small.

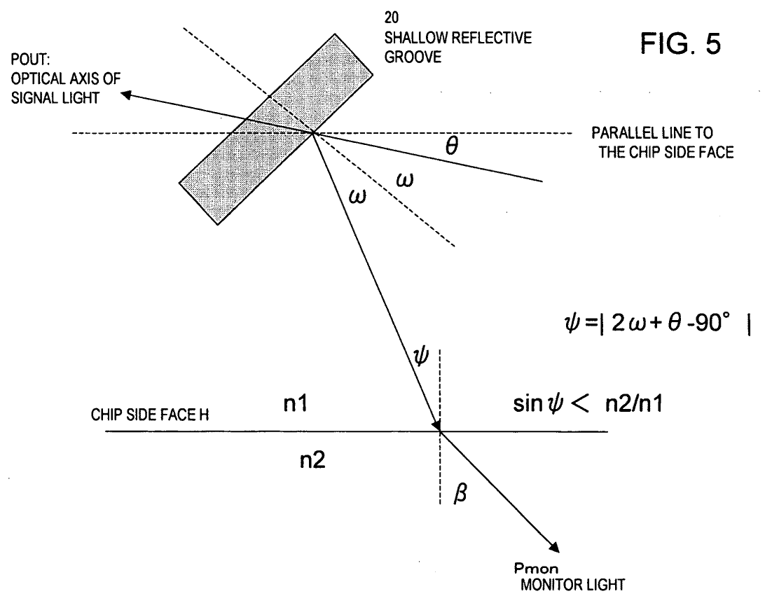

Further, as can be understood from the plan views illustrated in FIGS. 4A, 4B, reflective groove 20 is formed with an angle relative to waveguide 10. FIG. 5 is a schematic cross-sectional view between A and A′ depicted in FIG. 4A to explain the above-mentioned angle of the reflective groove 20.

As illustrated in FIG. 5, the optical axis of the output signal light Pout has an inclination of θ° relative to a chip side face H. Further, if reflective groove 20 is disposed with an inclination of ω° relative to the optical axis of the signal light, an incident angle ψ of the monitor light Pmon being incident on the chip side face H is expressed as ψ=|2ω+θ−90°|.

Now, let n1 to be the refractive index of the chip (2.14 in case of LN), and let n2 to be the refractive index of the outer side of the chip (normally 1, because of air). Then, it is necessary to satisfy (sin ψ)<(n2/n1), because the angle ψ of the monitor light Pmon incident on the side face of the chip is to be determined to prevent the occurrence of total reflection.

In other words, depending on the angle of reflective groove 20 relative to the optical axis, the monitor light Pmon is incident perpendicularly to the chip side face H. This causes the monitor light Pmon, reflected on the chip side face H, to return to reflective groove 20 intact. Further, on reflective groove 20, the reflection is made toward a signal light source (laser) on the input side of waveguide 10. The above-mentioned case is not preferable for use as an external modulator.

Therefore, to prevent the occurrence of such an inconvenience, the inclination θ relative to the optical axis of the signal light and the inclination ω of the reflective groove 20 relative to the optical axis of the signal light are determined.

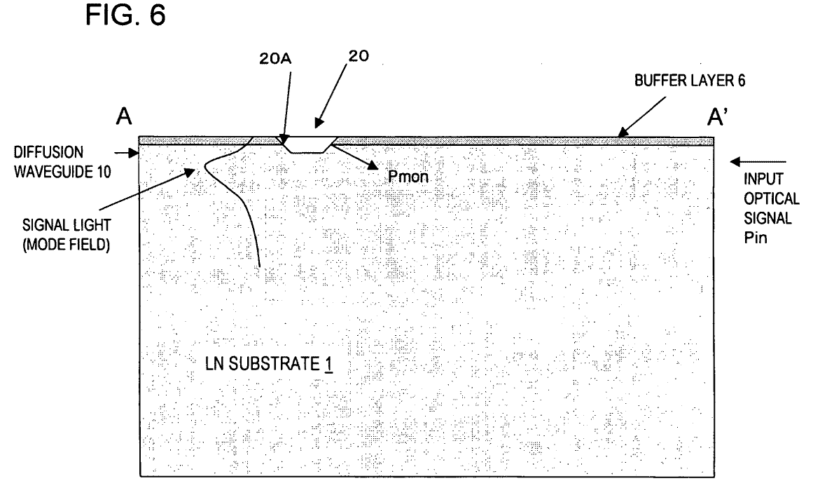

Alternatively, as another embodiment of reflective groove 20, the cross section shape thereof is formed so that the angle of side wall 20A of reflective groove 20 has an inclination angle, instead of being perpendicular. Namely, in FIG. 6, which illustrates a similar schematic cross-sectional view between A and A′ depicted in FIG. 4A, side wall 20A of reflective groove 20 has an inclination angle, differently from the configuration illustrated in FIG. 4C.

When viewed from the upper face, even if the monitor light Pmon is incident perpendicularly to the chip side face H (that is, ψ=0 in FIG. 5), the monitor light Pmon is reflected downward by the amount equal to the angle of side wall 20A of reflective groove 20, because of the angle in the thickness direction on side wall 20A of reflective groove 20. This prevents the occurrence of the above-mentioned problem such that the monitor light Pmon is perpendicularly reflected on the chip side face H, and returned to the direction of reflective groove 20. Here, it is necessary that the angle of side wall 20A of reflective groove 20 in the thickness direction is set to be such an angle as preventing the occurrence of total reflection on the chip side wall H.

Further, in FIG. 6, further advantage is obtained in the method that side wall 20A of reflective groove 20 has the angle applied in the thickness direction.

Namely, an individual optical waveguide device is cut out as a chip from the LN substrate of a wafer shape, using a dicing saw. At this time, the side cross-section on the upper end side of the chip has a coarse face after the cutout using the dicing saw. This affects the connection to an external optical fiber.

On the other hand, in the configuration illustrated in FIG. 6, because side wall 20A of reflective groove 20 has the angle applied in the thickness direction, the monitor light Pmon is a reflected light directed to the lower end direction opposite to the upper end direction of the chip. By this, it becomes possible to connect the monitor light Pmon to the external optical fiber, avoiding the coarse face on the upper end side of the chip.

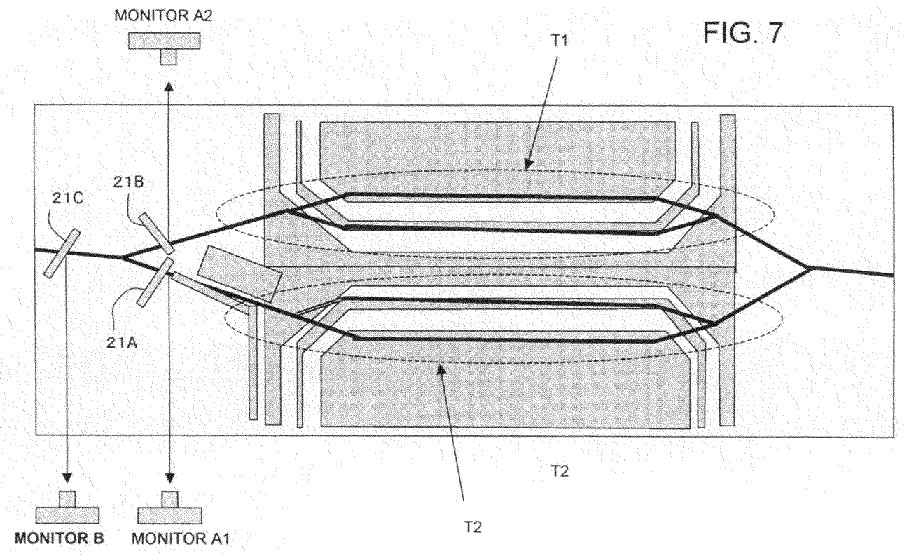

FIG. 7 illustrates an optical waveguide device having a feature that each optical waveguide of a pair of optical waveguides in the aforementioned Mach-Zehnder interferometer further configures a Mach-Zehnder interferometer.

The above embodiment is suitable for a vector modulator for DQPSK modulation scheme etc., being configured of a pair of Mach-Zehnder interferometers T1, T2.

In each pair of Mach-Zehnder interferometers T1, T2 constituting the vector modulator, shallow reflective grooves 21A, 21B and 21C are provided to receive the monitor light Pmon.

The configuration conditions of the respective reflective grooves 21A, 21B and 21C are the same as described before in regard to FIG. 4A.

Further, it is possible to use a similar configuration as a variable attenuator. By setting a light amount ratio of the signal light Pout to the monitor light Pmon to be a predetermined value, as an embodiment, it is possible to use as the variable attenuator. Further, in the variable attenuator also, in view of control, it is important to monitor the output light.

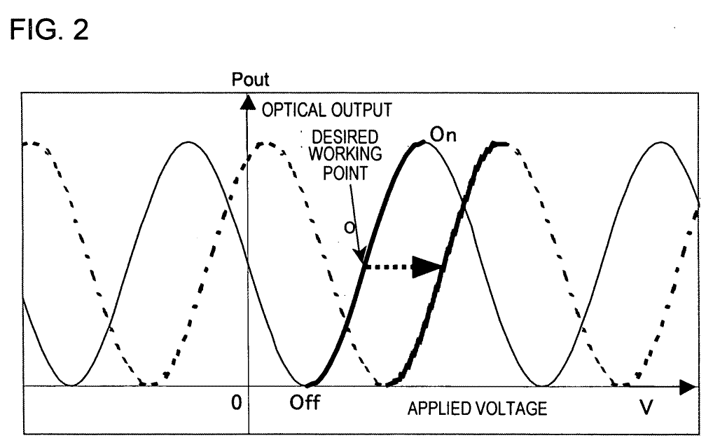

When the optical waveguide device is used as variable attenuator, in FIG. 2, an applied voltage is adjusted so as to obtain a desired light output between On and Off, centering the working point O. Then, by reading the monitor light power, the degree of a signal light power amount being presently output is known. Using this, feedback to the applied voltage is made so as to obtain a necessary light amount.

For example, assume that the light amount ratio of the monitor light to the signal light is 1:20. If the output of the monitor light is 1 μW, then it is known that the signal light output is 20 μW. Therefore, if it is desired to obtain the signal light output of 40 μW, the applied voltage is fed back so that the monitor light of 2 μW is output.

As such, it is preferable to design beforehand a suitable output ratio of the monitor light to the signal light.

In the following, an embodiment of the manufacturing process of the optical waveguide device having the above-mentioned configuration will be described.

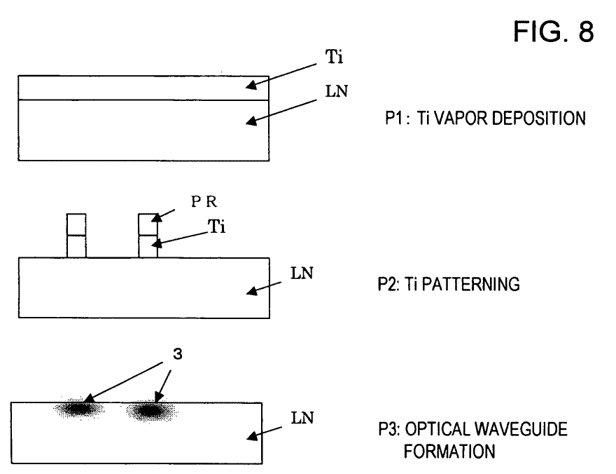

FIG. 8 illustrates charts illustrating exemplary processes until the formation of the optical waveguide is completed. In the following charts of manufacturing processes, for the sake of simplification, only a single optical waveguide device among a plurality of devices generated on a wafer substrate is depicted.

In FIG. 8, a Ti layer which is to be a waveguide is formed on a LiNbO₃ (LN) substrate 1 by vapor deposition, to a thickness of 1,000 Å (process P1).

Next, on the Ti layer after the vapor deposition, a photoresist PR is coated with a thickness of approximately 1 μm. Further, a photoresist coated by a general photolithography method is patterned. Using the above patterned photoresist as a mask, a Ti film is patterned (process P2).

At the time of the above patterning, either dry etching or wet etching is applicable. At this time, with modulator, switch, filter, VOA (variable optical attenuator), etc., a general directional coupler and a Mach-Zehnder interferometer having a Y branch are configured.

After patterning, Ti is diffused in the LN substrate at 1,000° C.-1,100° C., so as to form an optical waveguide (process P3).

Here, Mg may be used in place of Ti. Also, it may be possible to form the optical waveguide by a proton exchange method.

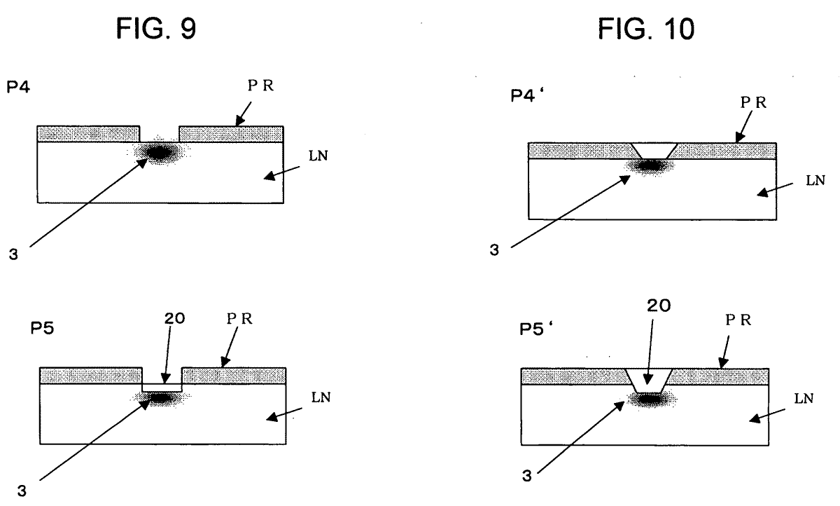

Next, FIG. 9 illustrates process charts to form reflective groove 20 corresponding to FIG. 4C. In FIG. 9, using a photolithography method, a groove formation pattern is generated on optical waveguide 3 to form reflective groove 20 thereon (process P4). Next, using the photoresist PR as a mask, groove 20 is formed by dry etching (process P5).

FIG. 10 illustrates process charts to form reflective groove 20 corresponding to FIG. 6. A process to form an angle on the side face of reflective groove 20 is depicted. In FIG. 10, by setting a post-bake temperature to be high, a post-bake time to be long, or the like, each side face of the aperture of a photoresist PR is made oblique (process P4′). Next, using the photoresist PR as a mask, reflective groove 20 is formed by dry etching (process P5′). By the above processes, it is possible to form angle on the side face of shallow reflective groove 20 being formed.

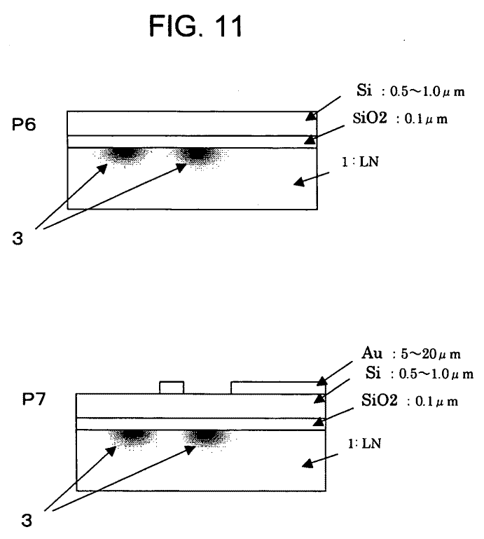

FIG. 11 illustrates charts illustrating an electrode formation process. As a process subsequent to the process P5 (P5′), an oxide film SiO₂ is vapor deposited as a buffer layer for preventing a light absorption loss by the electrode and for impedance matching. On the above buffer layer, a Si film having a thickness of 0.5-1.0 μm is coated on the entire face of the wafer i.e. the LN substrate (processing process P6).

The vapor deposition of the buffer layer (SiO₂ layer) is performed using spattering, an EB (electron beam) vapor deposition device, or the like. The thickness of the buffer layer is optimized according to a necessary bandwidth and an electric reflection amount, which is set to be around 0.5 μm to 1.0 μm in ordinary cases.

The coating of the Si film is also vapor deposited by spattering etc., with a thickness of appropriately 0.1 μm.

Further, for undercoating to plate an electrode of Au, Au vapor deposition is performed. This is also vapor deposited to the order of 0.1 μm by means of the EB vapor deposition device etc. After the resist is patterned, etching is performed, and Au plating for electrode is performed (process P7).

Similar to the buffer layer (SiO₂ layer), the thickness of the Au plating is optimized according to a bandwidth, electric reflection, etc., which is set to be 5-20 μm or of that order in ordinary cases.

Next, by cutting using a dicing saw of a desired size, an individual optical waveguide device chip is obtained.

Here, as an embodiment, not only the LN modulator, it is also possible to form using other dielectrics and polymer materials having larger electro-optic coefficients than LN (lithium niobate). Using the optical circuit pattern similar to the LN modulator, a variable attenuator can also be formed.

In this case, different from the LN waveguide, the film thickness of the portion of an overclad layer 10 over the core is generally several μm to several tens of μm. In that case, desirably, reflective groove 20 has a depth enough to reach either the vicinity of the core or a portion of the core. As to the generation method of reflective groove 20, it is possible to use etching such as RIE (reactive ion etching), similar to the case of LN.

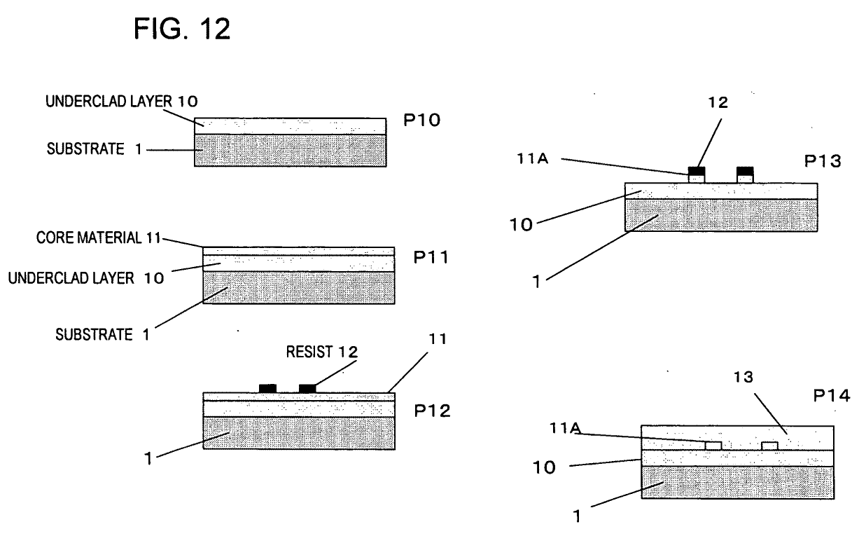

FIG. 12 illustrates charts illustrating exemplary processes of a second embodiment to form an optical waveguide using a dielectric and a polymer material.

In FIG. 12, an underclad layer 10 having a thickness of the order of 20 μm is formed on a Si substrate (or glass substrate) 1 by a spinner etc., using the polymer material (process P10).

Subsequently, similarly by using the spinner etc., a thin film of a core material 11 is formed to have a thickness of the order of 7 μm (process P11).

A resist 12 is coated thereon, and to obtain a desired waveguide circuit, resist 12 is patterned by a general photolithography method (process P12). By etching the above resist using RIE etc., a core 11A is formed to be a center of the mode field of waveguide 3 (process P13).

Further, an overclad layer 13 with a film thickness of approximately 20 μm is formed by a similar method to the case of underclad layer 10 (process P14).

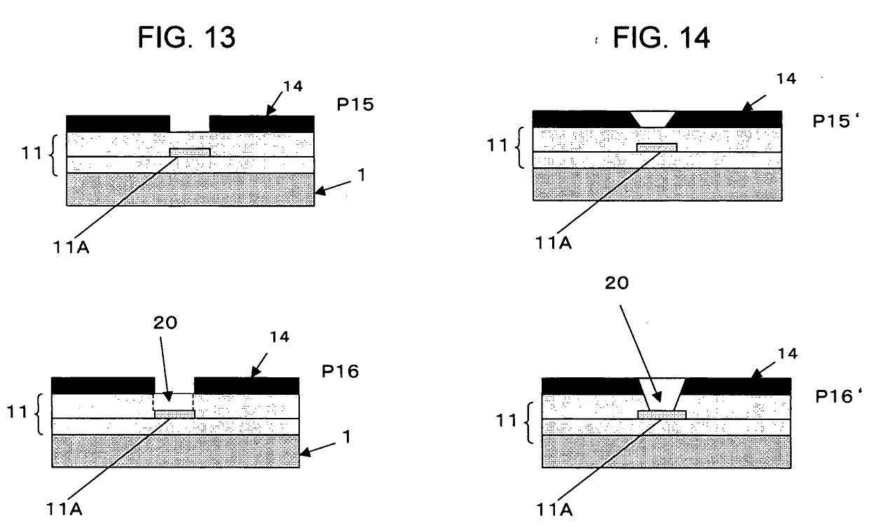

FIGS. 13, 14 illustrate charts illustrating a method for forming reflective groove 20 according to the second embodiment.

FIG. 13 corresponds to FIG. 4C. Also, FIG. 14 illustrates charts explaining a method for forming reflective groove 20 corresponding to FIG. 6.

In FIGS. 13 and 14, by the photolithography method, a resist 14 is patterned correspondingly to the area of reflective groove 20 (processes P15, P15′). Thereafter, by etching using RIE etc., reflective groove 20 is formed by a method similar to the method applied in the first embodiment (processes P16, P16′).

Reflective groove 20 has a depth enough to touch a portion of the mode field of waveguide 11. Here, the depth is determined to reach immediately before core 11A.

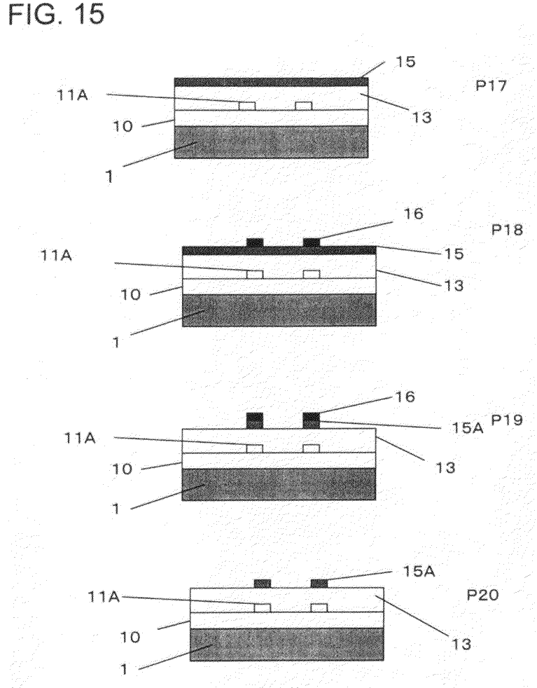

Next, an electrode is formed according to an electrode formation process illustrated in FIG. 15. In FIG. 15, first, Au 15 to form the electrode is vapor deposited to a thickness of 0.2 μm or of that order, using an electron beam (EB) vapor deposition device etc. (process P17).

By patterning a resist 16 by photo etching (process P18), an electrode pattern 15A is formed (process P19). Next, by cutting using a dicing saw of a desired size, an individual chip is obtained (process P20).

Now, as a third embodiment, by utilizing a thermo-optic effect instead of the electro-optic effect used in the second embodiment, it is possible to obtain an optical device which utilizes optical monitoring, such as a variable attenuator formed of a PLC (planar lightwave circuit) using a glass waveguide.

The configuration of the optical circuit in the above case is identical to the devices having been described above.

Referring to FIG. 12, which is used in the prior second embodiment, the third embodiment utilizing the thermo-optic effect will be described below.

As a process for forming an underclad layer corresponding to the process P10 depicted in FIG. 12, in the third embodiment, the underclad layer having a thickness of 20 μm or of that order is formed on a Si substrate or a glass substrate. Methods for forming the above-mentioned underclad layer include flame deposition method, CVD (chemical vapor deposition) method, spattering method, etc.

When using the glass waveguide in the third embodiment, the subsequent processes are identical to the processes P11-P14 depicted in FIG. 12.

In the above description of the embodiments, although the optical waveguide is exemplified by LiNbO₃ (LN) substrate 1, it is possible to be replaced by a Si substrate. Further, the above-mentioned optical waveguide 3 may also be formed of a polymer material, glass formed by the flame deposition method, glass formed by the CVD method, or glass formed by the spattering method.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present invention(s) has(have) been described in detail, it should be understood that the various changes, substitutions, and alterations could be made hereto without departing from the spirit and scope of the invention.

1. An optical waveguide device comprising:
a substrate;
an optical waveguide formed in a plane of the substrate and having a normal line with a predetermined angle relative to an optical axis of the optical waveguide;
a reflective groove formed on the optical waveguide; and
a monitor device to monitor an output light reflected by the reflective groove, wherein
the reflective groove has as much depth as approaching a half or less of a mode field of a waveguided light propagated through the optical waveguide, to reflect a portion of the waveguided light.

2. The optical waveguide device according to claim 1, wherein
the optical waveguide includes an input optical waveguide and an output waveguide, and there is further comprised an electrode formed on the substrate correspondingly to the optical waveguide, and wherein
the reflective groove is formed on the output waveguide with a normal line having a predetermined angle relative to an optical axis of the output waveguide; and the monitor device monitors output light reflected by the reflective groove.

3. The optical waveguide device according to claim 2, wherein
the substrate includes an end face on a light output side from the output waveguide and a side face, different from the end face, at which the monitor device is disposed to monitor a reflected light reflected by the reflective groove, and wherein
the predetermined angle of the normal line to the reflective groove is set to be an angle inhibiting the reflected light reflected by the reflective groove from being incident perpendicularly to the side face.

4. The optical waveguide device according to claim 3, wherein
the side face of the reflective groove has an inclination angle so that the reflected light by the reflective groove is directed to a depth direction from a surface side of the substrate.

5. The optical waveguide device according to claim 2, wherein
the optical waveguide includes a Mach-Zehnder interferometer between the input optical waveguide and the output waveguide, and wherein the Mach-Zehnder interferometer includes a pair of optical waveguides and couplers being disposed on an input side and an output side to couple the pair of optical waveguides, and wherein
the output waveguide having the reflective groove formed thereon is connected to the coupler on the output side.

6. The optical waveguide device according to claim 5, wherein
each optical waveguide of the pair of optical waveguides in the Mach-Zehnder interferometer further constitutes a Mach-Zehnder interferometer.

7. The optical waveguide device according to claim 1, wherein
the substrate is a LiNbO₃ substrate.

8. The optical waveguide device according to claim 7, wherein
the optical waveguide is formed by a method of Ti diffusion, Mg diffusion or proton exchange.

9. The optical waveguide device according to claim 1, wherein
the substrate is a Si substrate.

10. The optical waveguide device according to claim 9, wherein
the optical waveguide is formed of a polymer material, glass obtained by a flame deposition method, glass obtained by a CVD method, or glass obtained by a spattering method.

11. The optical waveguide device according to claim 1, wherein
a function as an external optical modulator is obtained by applying to the electrode a predetermined high frequency voltage based on a predetermined reference bias voltage.

12. The optical waveguide device according to claim 1, wherein,
a function as an attenuator to supply a predetermined attenuation value is obtained by applying to the electrode a predetermined voltage based on a predetermined reference bias voltage, the optical waveguide device
